(19) United States
(12) Patent Application Publication
(10) Pub. No.: US 2016/0012415 A1
(43) Pub. Date: Jan. 14, 2016

(54) APPARATUS AND METHOD FOR CONDUCTING A TRANSACTION, AND A CORRESPONDING COMPUTER PROGRAM AND COMPUTER-READABLE STORAGE MEDIUM

(71) Applicant: MasterCard Asia Pacific Pte. Ltd., Singapore (SG)

(72) Inventor: Yulia Surya, Singapore (SG)

(21) Appl. No.: 14/793,201

(22) Filed: Jul. 7, 2015

(30) Foreign Application Priority Data
Jul. 11, 2014 (SG) 10201404031T

(51) Int. Cl. G06Q 20/32; G06Q 20/10; H04L 29/06

(52) U.S. Cl. CPC G06Q 20/3274; H04L 67/42; G06Q 20/10

(57) ABSTRACT

A method for conducting a transaction, the method comprising: storing, in a database, a code in association with a first client identifier data and a product identifier data, the first client identifier data identifying a first client device, the product identifier data identifying a product of the first client device; receiving from a second client device the code and second client identifier data, the second client identifier data identifying the second client device; determining the product identifier data and the first client identifier data from the database using the received code; generating instruction data based on the received second client identifier data and the determined product identifier data; and sending the instruction data to a transaction processing system to instruct the first client device to release the product to the second client device.

### CROSS-REFERENCE TO RELATED APPLICATION

This application is a U.S. National Stage filing under 35 U.S.C. §119, based on and claiming benefit of and priority to SG Patent Application No. 10201404031T filed Jul. 11, 2014.

### FIELD OF INVENTION

The invention relates to an apparatus and a method for conducting a transaction, and a corresponding computer program and computer-readable storage medium.

### BACKGROUND

Currently, if a consumer wishes to pay for goods or services, the consumer may provide a payment card (e.g. credit card, debit card, etc) to a cashier at the merchant point-of-sale to pay for the goods or services. However, this mode of transaction requires the consumer to be in the same physical location as the merchant. In addition, consumers generally need to identify the product that they wish to purchase through one of the following methods: showing the physical item (a can of coke) or pointing to a specific item in the list (lottery entry, airtime top-up).

In the case of an online purchase of goods or services, the consumer may make payment by entering his payment card details in a merchant's website. In addition, consumers generally need to manually select the product from a list of products displayed on the merchant's website. However, this mode of transaction requires the consumer to be in the same digital location as the merchant. In other words, the consumer has to be accessing the merchant's website in order to initiate payment and to select the product.

Electronic financial transactions may also utilize QR-codes. For example, a consumer uses a suitable mobile application on his mobile electronic device (e.g. mobile phone, tablet computer) to browse goods or services for sale. To purchase a particular good or service, the mobile application may require the consumer to use the portable electronic device's camera to scan a QR-code to initiate the transaction. However, this mode of transaction requires the consumer to be in the same physical location as the QR-code. A need therefore exists to provide an apparatus and method for conducting a transaction, and a corresponding computer program and computer-readable storage medium that seeks to address at least the above-mentioned problems.

### SUMMARY

According to an aspect of the invention, there is provided a method for conducting a transaction, the method comprising: storing, in a database, a code in association with a first client identifier data and a product identifier data, the first client identifier data identifying a first client device, the product identifier data identifying a product of the first client device; receiving from a second client device the code and second client identifier data, the second client identifier data identifying the second client device; determining the product identifier data and the first client identifier data from the database using the received code; generating instruction data based on the received second client identifier data and the determined product identifier data; and sending the instruction data to a transaction processing system to instruct the first client device to release the product to the second client device.

The method may further comprise receiving from the first client device the first client identifier data and the product identifier data, and generating the code based on the received first client identifier data and the received product identifier data.

The method may further comprise receiving additional data from the second client device, the additional data being associated with the product, and wherein the instruction data is generated based on the received additional data.

The instruction data may comprise one or more of: the product identifier data, the first client identifier data, the second client identifier data, and the additional data.

The method may further comprise authorizing and fulfilling the transaction using the transaction processing system.

The method may further comprise authenticating the second client device based on the received second client identifier data prior to generating the instruction data.

The method may further comprise sending a notification data to the second client device, the notification data confirming whether or not the instruction data has been sent to the first client device.

The method may further comprise notifying the second client device of the code prior to receiving the code from the second client device.

Notifying may comprise broadcasting the code by radio and/or television; displaying the code on one or more printed posters; and/or presenting the code on a website or in an email.

The product may comprise a digital good or service.

Receiving the code from the second client device comprises receiving the code in a short message service (SMS) message or from a mobile software application.

The code may comprise a string of alpha-numeric characters.

According to a second aspect of the present invention, there is provided an apparatus for conducting a transaction, the apparatus comprising: at least one processor; and at least one memory including computer program code; the at least one memory and the computer program code configured to, with at least one processor, cause the apparatus at least to: store, in a database, a code in association with a first client identifier data and a product identifier data, the first client identifier data identifying a first client device, the product identifier data identifying a product of the first client device; receive from a second client device the code and a second client identifier data, the second client identifier data identifying the second client device; determine the product identifier data and the first client identifier data from the database using the received code; generate an instruction data based on the received second client identifier data and the determined product identifier data ; and send the instruction to a transaction processing platform system to instruct the first client device to release the product to the second client device.

There is also disclosed a computer-readable storage medium having stored thereon computer program code which when executed by a computer causes the computer to execute a method as defined in the first aspect.

There is also disclosed a computer program comprising software code adapted to perform a method as defined in the first aspect.

### BRIEF DESCRIPTION OF THE DRAWINGS

Example embodiments of the invention will be better understood and readily apparent to one of ordinary skill in the art from the following written description, by way of example only, and in conjunction with the drawings, in which:

FIG. 1a is a flow chart illustrating a method of conducting an electronic transaction, according to an embodiment of the invention;

FIG. 1b is a tabular representation of the manner in which codes and their respective attributes are stored in a database, according to an embodiment of the invention;

FIG. 2 is a system architecture diagram of a system for conducting an electronic transaction, according to an embodiment of the invention;

FIG. 3 is a zoomed-in system architecture diagram of the system for conducting an electronic transaction, according to an embodiment of the invention;

FIG. 4 is a schematic illustrating the request phase of a method of conducting an electronic transaction, according to an embodiment of the invention;

FIG. 5 is a schematic illustrating the response phase of a method of conducting an electronic transaction, according to an embodiment of the invention; and

FIG. 6 is a schematic of a computer system for implementing the system and method for conducting an electronic transaction in example embodiments of the invention.

### DETAILED DESCRIPTION

Embodiments of the present invention will be described with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods disclosed herein. Such apparatus may be specially constructed for the required purposes, or may comprise a general purpose computer or other device selectively activated or reconfigured by a computer program stored in the computer. The algorithms and displays presented herein are not inherently related to any particular computer or other apparatus. Various general purpose machines may be used with programs in accordance with the teachings herein. Alternatively, the construction of more specialized apparatus to perform the required method steps may be appropriate. The structure of a conventional general purpose computer will appear from the description below.

In addition, the present specification also implicitly discloses a computer program and the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer readable medium may also include a hard-wired medium such as exemplified in the Internet system, or wireless medium such as exemplified in the GSM, GPRS, 3G or 4G mobile telephone systems. The computer program when loaded and executed on such a general-purpose computer effectively results in an apparatus that implements the steps of the preferred method.

The invention may also be implemented as hardware modules. More particular, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist.

Those skilled in the art will appreciate that the system can also be implemented as a combination of hardware and software modules.

Some embodiments of the present invention relate to an apparatus, a method, a corresponding computer program and computer-readable storage medium that can provide a standard template and mechanism for merchants to accept consumer payments without the presence of a physical store, person or online website, through the generation, broadcasting and receipt of purchase codes associated with the merchant and the good or service being offered for sale.

Some embodiments of the present invention can also be used in non-financial electronic transactions (i.e. transactions that do not involve monetary payment in exchange for goods and/or services). An example of a non-financial electronic transaction is the redemption of customer loyalty rewards (e.g. frequent flyer miles, credit card points).

For example, a customer loyalty reward program can be administered without the presence of a physical store, person, or online website, through the generation and broadcasting of standard redemption codes associated with the merchant and the good or service being offered for redemption. Consumers can redeem the desired good or service using the appropriate redemption code.

It is to be understood that, in an embodiment, the transaction is between a consumer and a merchant. For example, the consumer may wish to purchase a product from the merchant in exchange for providing a payment to the merchant. However, as mentioned above, in some embodiments, the transaction may not be financial in nature. Therefore, the term ‘merchant’ and ‘consumer’ are understood to be examples of a ‘first client’ and a ‘second client’, respectively, wherein both the first and second clients are party to the transaction. Further, the ‘first client’ participates in the transaction using a device referred to as a ‘first client device’. Similarly, the ‘second client’ participates in the transaction using a device referred to as a ‘second client device’. In the description which follows, for simplicity, the terms ‘merchant’ and ‘consumer’ will be used. However, in an embodiment, these terms may be interchanged with ‘first client’ and ‘second client’, respectively.

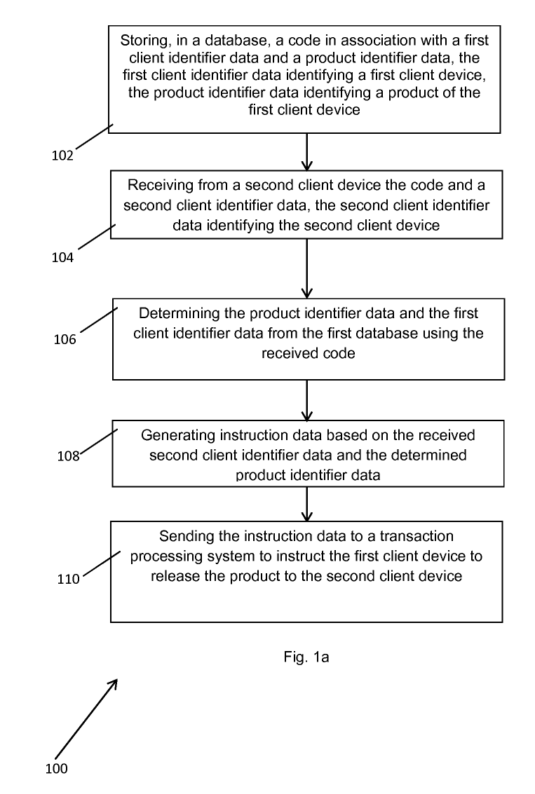

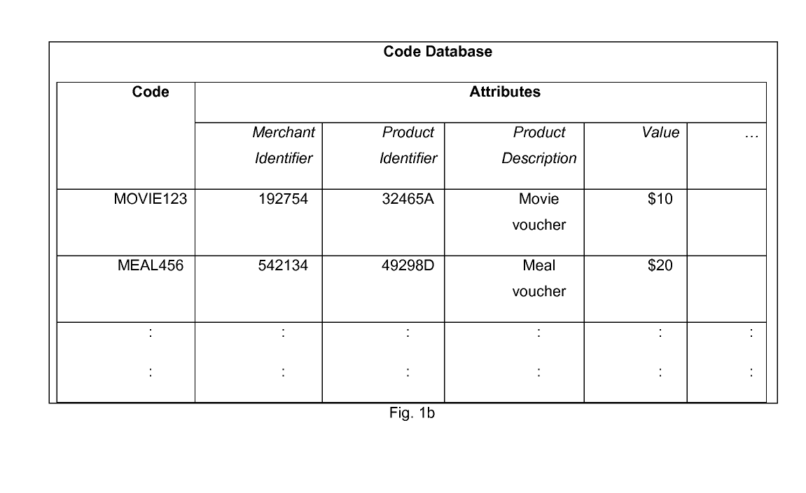

With reference to FIG. 1a, in an example embodiment, there is provided a method 100 for conducting a transaction, comprising the following steps:

Step 102

At step 102, a code associated with at least a merchant (“first client”) identifier and a product identifier is stored in a database, the merchant identifier identifying a merchant, and the product identifier identifying a product (i.e. good or service) of the merchant. In an example embodiment, the code may be further associated with a product description and/or value of the product. Hereinafter, for the sake of conciseness, the terms “merchant identifier”, “product identifier”, “product description”, “value of the product” may be collectively referred to as “attributes”.

Also, hereinafter, the term “code” may refer to a purchase code, redemption code, or any form/type of code, symbol, character, etc. The code is associated with at least a merchant (“first client”) identifier and a product identifier; and optionally further associated with a product description and/or value of the product. The code is stored in a database, and mapped together with its attributes. In an example embodiment, the code may comprise a string of alpha-numeric characters. However, in other embodiments, the code may additionally or alternatively comprise a string of any other type of character, for example, special (e.g. !, #, %, *), Chinese, Japanese, Korean, Arabic characters.

The codes are unique in the sense that each code is associated with a specific set of attributes. That is, no two codes have the same set of attributes. In this manner, the codes can be used to identify a particular product (having a particular value), the merchant offering the product, and the product description.

For example, if a merchant (with merchant identifier “192754”) offers a movie voucher worth $10 for sale, and the code is “MOVIE123”, the above information may be stored in the database in the format shown in FIG. 1b.

The database can store a plurality of codes (only two are shown in FIG. 1b) in association with its respective attributes—e.g. merchant identifier, product identifier, product description and/or value of the product.

The code may be generated based on the methods described herein or based on other means. For example, the code may be manually assigned (e.g. by the merchant) based on a set of rules or arbitrarily assigned. In an exemplary embodiment, the code is (i) a string of characters comprising at least a part of an attribute or (ii) a combination of at least a part of two or more attributes. For example, if a merchant “A” offers a movie voucher for sale, and the movie voucher's product identifier is “MOVIE”, the code can be (i) “MOVIE” or (ii) “A_MOVIE”.

A code having this format can be viewed as a logical/intelligible string of characters. Accordingly, it is expected that such a code is more easily committed to memory than a random string of characters or a graphical representation (e.g. QR code, bar code). For example, if a code “MOVIE” corresponds to a movie voucher, it is easier for consumers to remember the code when purchasing the movie voucher rather than if the code comprised a random string of characters or a graphical representation.

In an example embodiment, the code is generated by appending the merchant identifier to the product identifier, with an underscore in-between. Therefore, if a merchant “A” offers a movie voucher for sale, and the movie voucher's product identifier is “XYZ”, the code is generated by appending “A” to “XYZ” with an underscore in between to arrive at code “A_XYZ”.

In the example of a financial transaction, each merchant that is participating in the method offers goods or services for sale to consumers. Each merchant is assigned a unique merchant identifier and each good or service that is offered for sale by the merchant is assigned a unique product identifier. If a good or service has more than one value/denomination, each value of the good or service may be assigned a unique product identifier. Codes are generated based on the merchant identifiers and the product identifiers.

For example, merchant A offers for sale: (i) movie vouchers worth $10 and (ii) movie vouchers worth $20. The generated purchase codes associated with (i) and (ii) may be “A_XYZ1” and “A_XYZ2”. In an example embodiment, the purchase code may comprise alpha-numeric characters. However, in other embodiments, the code may comprise any other type of character, for example, Chinese, Japanese, Korean, Arabic characters.

In the example of a non-financial electronic transaction (i.e. a transaction that does not involve monetary payment in exchange for goods and/or services) such as the redemption of customer loyalty rewards, each merchant that is participating in the method offers goods or services for redemption to consumers. Each merchant is assigned a unique merchant identifier and each good or service that is offered for redemption by the merchant is assigned a unique product identifier. Likewise, if a good or service has more than one value, each value may be assigned a unique product identifier.

In another example embodiment, in addition to generating the code based on a merchant identifier and a product identifier, the code may be generated based on a value of the product and/or product description. Continuing from the example above where merchant “A” offers a movie voucher for sale and the movie voucher's product identifier is “XYZ”, assume the value of the voucher is $10 and the product description is “MOVIE_VOUCHER”. The code may be generated based on the value of the product and product description, e.g. by including the value of the product and product description in the code such as “$10_MOVIE_VOUCHER”. In this manner, the code may be more descriptive and possibly more easily remembered than a code that is generated by appending the merchant identifier to the product identifier.

In an embodiment, a consumer (“second client”) is notified of the code. The consumer may be notified of both the code and its association with the merchant and the good or service. The code and/or its association with the merchant and the good or service may be notified to consumers through broadcast, print and/or digital media. In this context, broadcast media includes, but is not limited to radio, film and television. Print media includes, but is not limited to, posters, newspapers, books, magazines, pamphlets, brochures and billboards. Digital media includes, but is not limited to, email, websites, blogs and internet based radio and television. In an embodiment, notifying the consumer of the code comprises broadcasting the code by radio and/or television; displaying the code on one or more printed posters; and/or presenting the code on a website or in an email.

For example, a consumer, while waiting for a bus at a bus stop, sees a printed advertisement for merchant A's $10 and $20 movie vouchers. The advertisement also indicates that the purchase code “A_XYZ1” can be used to purchase a movie voucher worth $10, while the purchase code “A_XYZ2” “can be used to purchase a movie voucher worth $20. The advertisement may also include instructions for purchasing the vouchers. For example, the instructions may be “To buy the movie voucher worth $10, SMS “BUY A_{—} XYZ1” to 123456”.

Each consumer is assigned a unique consumer identifier or credential for identification purposes. For example, the consumer identifier can be one or more of: a mobile phone number, a passport number, an identity card number, social security number, name, pre-assigned user identifier, etc. Hereinafter, for the sake of conciseness, the term “consumer identifier” is meant to refer to a unique consumer identifier, credential, code, etc. for identification purposes. For the case of a financial transaction, the unique consumer identifier may be a payment identifier such as a credit card number or bank account number that is used for facilitating payment processing.

In an embodiment, prior to generating the code, attributes are received from the merchant. Example attributes may include one or more of: (i) a merchant identifier associated with the merchant, (ii) a product identifier associated with the good or service (i.e. product), (iii) a value of the good or service, and (iv) a product description. Each merchant is assigned a unique merchant identifier. Each good or service that is offered for sale by the merchant is assigned a unique product identifier. Some goods or services can come in more than one value. For example, a voucher can have multiple values. The product description is preferably a short description of the product (e.g. “MOVIE_VOUCHER”). The code and its associated attributes are stored in a database.

The code may be generated based on one of more of the received attributes as described above. For example, the merchant can access a website that allows the merchant to enter the attributes. The website may then display the generated code based on the entered attribute data.

Alternatively, merchants can provide a list of goods or services to a third party (e.g. a system administrator) for code generation. The third party can generate the code and inform the merchants of the unique codes that correspond to the goods or services. The generated codes and its associated attributes are stored in a database.

Step 104

At step 104, the code and a consumer identifier is received from a consumer, the consumer identifier identifying the consumer. For example, the code may be received from one or more consumers who may wish to purchase the good or service. The respective unique consumer identifiers are also received so that each consumer who wishes to purchase the good or service may be identified. The unique consumer identifiers include, but are not limited to: a consumer's mobile phone number, name, pre-assigned user id, credit card number or bank account number.

Continuing from the example above, the consumer is interested in the $10 movie voucher and notes down the purchase code, e.g. mentally, or on paper. The consumer boards the bus for home. At home, the consumer decides to purchase the $10 movie voucher. He may then send a SMS message having the content “BUY A_{—} XYZ1” to 123456. In this example, the consumer and the merchant are in a different physical and digital location. In other words, the consumer does not need to be physically at the merchant's physical store or on its website to initiate the transaction. The consumer also does not need to be in the presence of the bus stop advertisement to initiate the transaction compared to the instance of QR-codes. As such, embodiments of the invention advantageously allow consumer(s) to make payment anytime and from anywhere.

As illustrated above, the code may be received from the consumer by means of a short message service (SMS). However, the code may be received using other suitable means, such as a mobile software application that is installed in the consumer's mobile computing/communication device (e.g. mobile telephone) or via a website. The mobile application can be administered by a third party (i.e. not the merchant) such as a financial institution (e.g. banks, credit card issuers, etc).

Continuing from the example above, if the purchase code is received from the consumer by means of a short message service (SMS) and the consumer has pre-registered his mobile phone number, the consumer identifier can be the consumer's mobile phone number. The consumer does not need to explicitly provide his consumer identifier since the mobile phone number can be determined from the SMS message.

Alternatively, in addition to providing the code, the consumer explicitly provides his consumer identifier. For example, he may send an SMS text message “BUY A_{—} XYZ1 JOHN” to 123456, “JOHN” being his unique consumer identifier.

The consumer who wishes to purchase the good or service is identified based on his/her respective unique consumer identifier that is received. In an embodiment, identifying the consumer based on the received consumer identifier comprises consulting/using a database that stores the received consumer identifier in association with particulars of the consumer.

Continuing from the example above, if the consumer identifier is the consumer's mobile phone number, the consumer can be identified based on his mobile phone number. For example, a database can be provided, which stores the particulars of each consumer (e.g. consumer identifier; and corresponding name, billing address, bank account number, etc.). Upon receipt of the SMS message, the consumer's mobile phone number can be extracted from the SMS message, for example, via caller ID. The extracted mobile phone number (i.e. consumer identifier) can be used to identify the consumer by consulting/using the database to determine which consumer is associated with the extracted mobile phone number.

If the consumer explicitly provides his unique consumer identifier, e.g. sending an SMS message having the content “BUY A_{—} XYZ1 JOHN” to 123456, the consumer identifier can be extracted using any known techniques and the extracted consumer identifier can be used to identify the consumer.

Step 106

At step 106, the product identifier and the merchant identifier are determined from the database that stores the code in association with at least the product identifier and the merchant identifier using the received code.

Optionally, other attributes (e.g. product description, value of the product) can be determined using the received code if the other attributes are stored in the database in association with the code.

The attributes can be determined by looking up the database that stores the code in association with its attributes by locating the code and identifying the attributes that are associated with the located code. For example, with reference to FIG. 1b above, if the received code is “MOVIE123”, the corresponding attributes can be determined by looking up the database, locating the code, and identifying the associated attributes—Merchant Identifier “192754”, Product Identifier “32465A”, Product “Movie voucher” and Value is “$10”.

After the product identifier is determined, the good or service that the consumer wishes to purchase/redeem is known. Similarly, after the merchant identifier is determined, the merchant which offers the good or service that the consumer wishes to purchase/redeem is known. Determining at least the product identifier and the merchant identifier facilitates the releasing of the correct product from the correct merchant to the correct consumer.

Step 108

At step 108, an instruction based on at least the received consumer identifier and the determined product identifier is generated. The generated instruction facilitates the releasing of the correct product from the correct merchant to the correct consumer. In an embodiment, the instruction may be generated based on other additional attributes, such as merchant identifier, product description and/or value of the product.

In an embodiment, the instruction may be a message comprising one or more of: the product identifier, the merchant identifier, the consumer identifier, and the additional information. The message may be in a standard format (e.g. an ISO message).

Step 110

At step 110, the instruction is sent to a transaction processing platform to instruct the merchant to release the product to the consumer.

The instruction may be indirectly or directly sent to the transaction processing platform. For example, the instruction may be indirectly sent to the transaction processing platform via a payment gateway. In an embodiment, the transaction processing platform is configured to process, at least, authorization and fulfillment of the transaction. If the transaction is authorized, the merchant may be instructed to release the product to the consumer.

In this context, “release” refers to the sending/delivery/provision of the good or service to the consumer at his address. For example, a movie voucher can be sent to the consumer, and the movie voucher can be exchanged for a movie ticket at the box office. In an embodiment, “sending” may be digital (e.g. via SMS or email) or physical (e.g. a paper voucher is posted by mail).

In an embodiment, merchants can be notified of the purchase of the good or service. Consumers can also be notified of the release of the good or service. For example, a notification can be sent to the consumer, the notification confirming whether or not the merchant has released the product to the consumer. The notifications can be in any form, for example, a short message service (SMS), a notification being displayed in a mobile application, or an email. In an embodiment, merchants can be notified that the good or service has been released to the consumer.

In an embodiment, the good or service comprises a non-physical digital good or service and optionally with a fixed value. Examples of non-physical digital goods or services include vouchers, charity donations, tickets and media files (e.g. songs, movies).

In an embodiment, the method may further comprise authenticating each of the consumers who may wish to purchase the good or service prior to generating the instruction (i.e. step 108). For example, the consumers can be asked to provide their personal identification number (PIN) for authentication after sending an SMS message having the content “BUY A_XYZ1” to 123456.

An example of a SMS trail is as follows:
Send: BUY A XYZ1
Reply: Enter PIN
Send: PASSWORD
Reply: Thank you for purchasing a $10 movie voucher from merchant A. The voucher code is 1234 5678. Please present this voucher code at the box office to redeem the movie voucher.

In an embodiment, the method may further comprise receiving additional information from the consumer. The additional information may be associated with the good or service. The identified good or service may be released to the identified consumer based on the received additional information. In other words, the instruction is generated (see step 108 above) to include the received additional information. That is, the instruction may specify the additional information.

The additional information may include, but is not limited to, the quantity of the good or service to be purchased, additional reference information, delivery address, shipping method and special instructions to the merchant (e.g. release the good or service in one week's time). In the example of the additional information being the quantity of the good or service to be purchased, the instruction specifies the quantity of the product to be released.

An example of a SMS trail which allows consumer(s) to input additional purchase information is as follows:
Send: BUY A_XYZ1
Reply: Enter PIN
Send: PASSWORD
Reply: How many $10 movie vouchers do you wish to purchase?
Send: 3
Reply: Thank you for purchasing three $10 movie voucher from XYZ. The voucher codes are 1111 1111, 2222 2222 and 3333 3333. Please present these voucher codes at the box office to redeem the movie vouchers.

In the above example, the additional purchase information is the quantity of the good or service to be purchased, i.e. three.

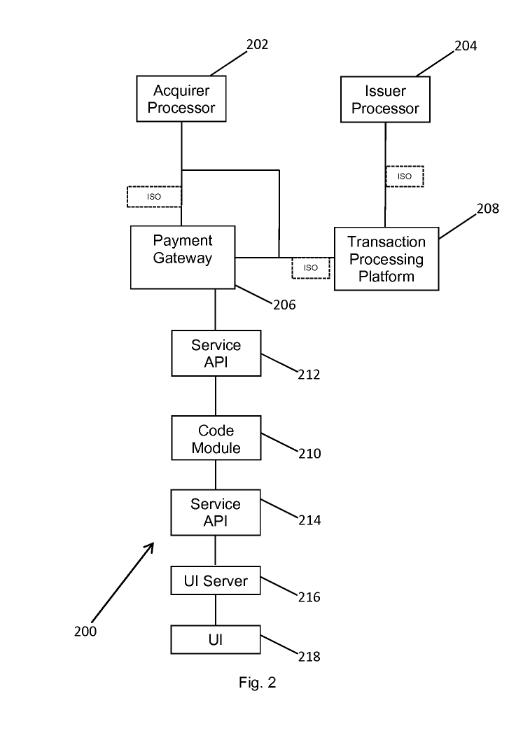

In an embodiment, if the transaction is a financial transaction, the instruction may be a payment processing request that is sent to the transaction processing platform via a payment gateway (see FIG. 2). The payment processing request includes the information required to process the payment, such as a merchant identifier, consumer identifier, product identifier, and/or value of the product.

The specific payment processing steps are known in the art and are not the focus of the invention. Therefore, for conciseness, the specific payment processing steps will not be elaborated upon.

After the payment is processed, a payment confirmation may be received from the payment gateway to indicate that the payment is successful (e.g. there are sufficient funds in an account of the consumer). The merchant releases the product to the customer only if the payment is successful.

On the other hand, if the payment is unsuccessful (e.g. there are insufficient funds in an account of the consumer), a payment confirmation is not sent by the payment gateway. Instead, an unsuccessful payment message may be sent by the payment gateway. In this case, the merchant does not release the product to the customer.

In an embodiment, there is provided a computer-readable storage medium having stored thereon computer program code which when executed by a computer causes the computer to execute a method according to an embodiment of the invention as described above.

In an embodiment, there is provided a computer program comprising software code adapted to perform a method according to an embodiment of the invention as described above.

FIG. 2 is a system architecture diagram of a system 200 that may be used to implement the method of conducting an electronic transaction described above. In one exemplary embodiment, the system 200 comprises the following components: an acquirer processor 202, an issuer processor 204, a payment gateway 206, a transaction processing platform 208, a code module 210, service application program interfaces (API) 212/214, a user interface (UI) server 216 and a user interface (UI) 218. These components and their respective functions will be described in detail below. The system 200 is suitable for implementing a method of conducting a financial transaction.

The acquirer processor 202 is in communication with the payment gateway 206 and the transaction processing platform 208. The issuer processor 204 is in communication with the transaction processing platform 208. The payment gateway 206 may also be in communication with the transaction processing platform 208. The user interface (UI) server 216 is in communication with the code module 210 via the service application program interface (API) 214. The code module 210 is in communication with the payment gateway 206 via service API 212. The user interface (UI) server 216 is configured to control the user interface (UI) 218. It is to be understood that ‘in communication with’ is intended to include both a ‘direct’ communication link between both elements and an ‘indirect’ communication link between both elements, an indirect link being via one or more other elements or networks.

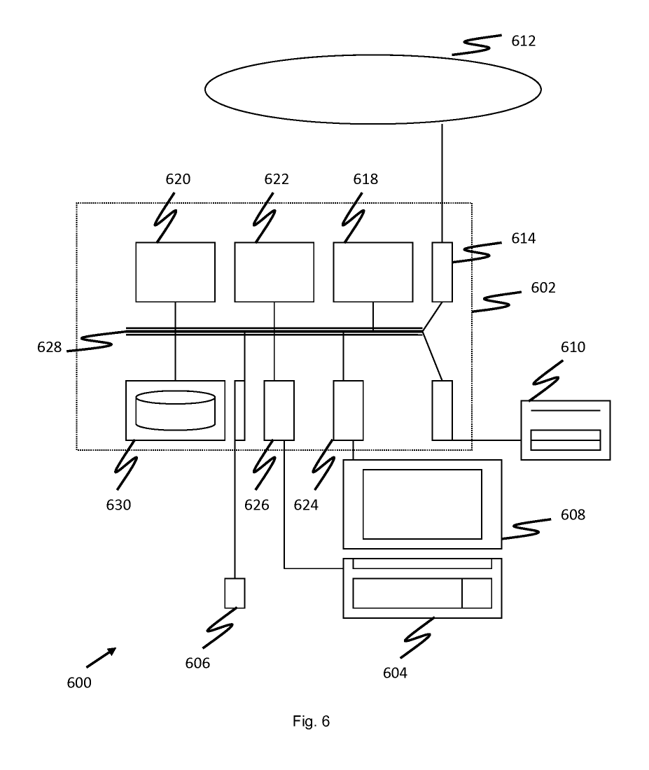

In an embodiment, the acquirer processor 202, issuer processor 204, payment gateway 206, transaction processing platform 208, code module 210, service application program interfaces (API) 212/214, user interface (UI) server 216 and/or user interface (UI) 218 are each a computer system, part of a computer system or a plurality of interconnected computer systems. In this way, each element may be provided by a single physical apparatus or distributed across a number of different physical apparatuses. Additionally, one or more elements may be provided by a single physical apparatus. An exemplary computer system is described below with reference to FIG. 6.

Acquirer Processor

The acquirer processor 202 is the processing system of an acquiring bank. The acquiring bank primarily processes credit and/or debit card payments for goods or services for merchants. The acquirer processor 202 is configured to process transactions initiated by merchants or any systems on behalf of merchants, and is also involved in the clearing/settlement process. The acquirer processor 202 interacts with the payment gateway 206 so that the acquirer processor 202 can process transactions initiated by consumers in a similar fashion.

A payment network administrator (e.g. MasterCard®), who facilitates payments between entities (e.g. an acquiring bank and an issuing bank), may interact with the acquirer processor 202.

Issuer Processor

The issuer processor 204 is the processing system of an issuing bank. The issuing bank primarily processes credit and/or debit card payments for goods or services for consumers. The issuer processor 204 is configured to authorize transactions performed against the consumer's account issued by the issuing bank, and is also involved in the clearing/settlement process.

A payment facilitator (e.g. MasterCard®), who facilitates payments between entities (e.g. an acquiring bank and an issuing bank), may interact with the issuer processor 204.

Payment Gateway The payment gateway 206 is an e-commerce application service provider service that facilitates the authorization of electronic transactions. An example of a payment gateway is MasterCard® Mobile Payments Gateway, which facilitates mobile consumer-initiated transactions, such as electronic transactions according to an embodiment of the invention. The payment gateway 206 is typically administered by the payment facilitator (e.g. MasterCard®).

The payment gateway 206 communicates with the acquirer processor 202 using a common standard and format, e.g. an ISO message.

Code Module

The code module 210 facilitates the execution of code-based transactions.

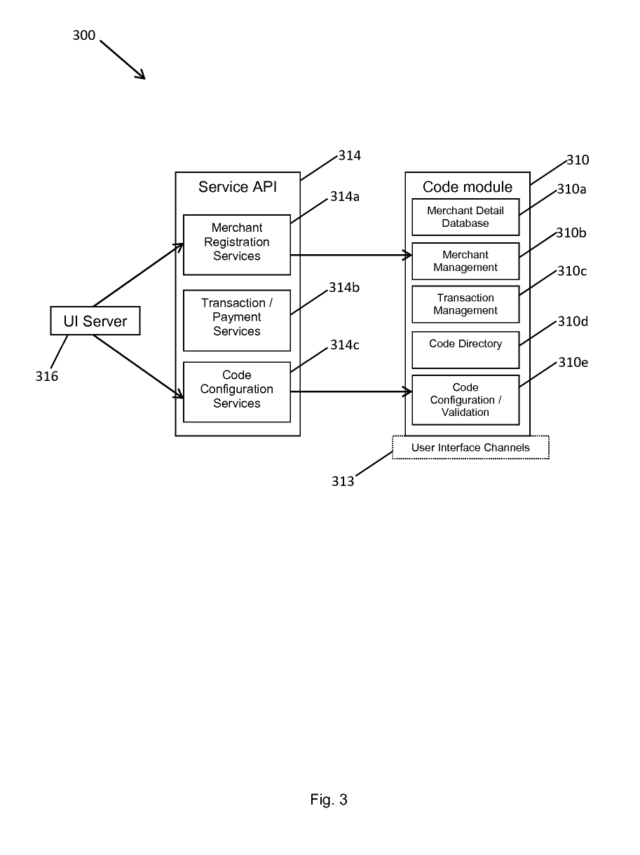

The components of the code module 210 will now be described in detail with reference to FIG. 3.

FIG. 3 is a zoomed-in system architecture diagram of a system for conducting an electronic transaction, focusing on the UI server 316, service API 314 and code module 310.

The code module 310 comprises five components: a merchant detail database 310a, merchant management component 310b, transaction management component 310c, code directory database 310d and code configuration component 310e.

The merchant detail database 310a stores the details of merchants who have registered to participate in the code-based transaction method. The status (e.g. active/inactive/suspended) of each merchant may also be stored in the database.

The merchant management component 310b is configured to process the registration and management of the merchants who have registered to participate in the code-based transaction method. The details of registered merchants are stored in the merchant detail database 310a.

The transaction management component 310c is configured to manage the retrieval of merchant detail based on the code (see step 106 above), retrieval of the product identifier, and the submission of transaction detail to the payment gateway 206.

The code directory database 310d stores the codes against its corresponding attributes (e.g. merchant identifier, product identifier, product description and/or value of the product), for example, in the format shown in FIG. 1b.

The code configuration/validation component 310e is configured to manage the storing of the codes (in the code directory database 310d) and also configured to validate the codes.

In an embodiment, the steps involved in validating the code are as follows:
1. Receive attributes (“merchant identifier”, “product identifier”, “product description”, “value of the product”) and corresponding preliminary code to be assigned.
2. Validate all received attributes. For example, a check is performed to determine whether the received “merchant identifier” exists.
3. Check if the merchant (corresponding to the received “merchant identifier”) is registered and active by consulting the merchant detail database 310a.
4. If the merchant is registered and active, validate the chosen preliminary code/automatically generated code to be assigned. For example, a check can be performed to determine whether or not the code is unique and/or contains blacklisted words.
5. Upon successful validation, store the code in the code directory database 310d and mark it as “active”. Otherwise, generate another preliminary code for re-validation.

In an embodiment, in addition to the exposed API, the code module 310 may also include a ready-use front-end application for the exposed API services via user interface channels 313.

Transaction Processing Platform The transaction processing platform 208 is configured to process the transaction, e.g.

authorization and fulfillment of the transaction. The transaction may be a financial or non-financial transaction.

In the case of a financial transaction, the transaction processing platform 208 is configured to process transactions between acquirers and issuers. The acquirer processor 202 and issuer processor 204 preferably communicate with the transaction processing platform 208 using a common communication standard, e.g. ISO 8583. ISO 8583 defines a message format and a communication flow so that the acquirer processor 202, issuer processor 204 and the transaction processing platform 208 can exchange data (e.g. transaction requests and responses) with each other.

The transaction processing platform 208 is typically administered by the payment facilitator.

Service Application Program Interface (API)

In an embodiment, the API 212/214 may be a Simple Object Access Protocol (SOAP) or Representational State Transfer (REST) API.

In an example embodiment, three main types of services may be provided. Details of the three main types of services will now be described in detail with reference to FIG. 3.
i. Transaction/payment services 314b
   For the provision of transaction/payment services, a set of API is exposed to allow the UI server 216/316 to pass the requests from a consumer's UI 218 (e.g. of a mobile application installed on his smartphone).
   The payment services include functionalities for transactions according to embodiments of the invention (i.e. transactions using a unique code associated with both a merchant and a good or service).
ii. Code configuration services 314c
   A set of API is exposed for the provision of code assignment and management (e.g. update/delete) against a set of attributes/merchant details.
   In an example embodiment, the code configuration services may be processed by the code configuration/validation component 310e.
iii. Registration/setup services 314a
   A set of API is exposed for the provision of a set of services to enable merchants to participate in the code-based transaction system.
   In an example embodiment, the registration/setup services may be processed by the merchant management component 310b.

User Interface Server

The user interface (UI) server 216 is configured to control the user interface (UI) 218, and interact with the payment gateway 206 through an API such as SOAP or REST in order to perform a consumer's request.

The user interface server 216 is usually external to the payment facilitator (i.e. not administered by the payment facilitator).

In another embodiment, instead of a UI server, some other third-party system may be used to interact with the code module 210.

User Interface (UI)

The user interface (UI) 218 enables end-consumers to initiate electronic transactions according to embodiments of the invention and/or perform other end-user settings. The UI may be implemented via an Internet portal, a software application installed on a mobile electronic device, Short Message Service (SMS), etc.

For certain setup functionalities, the UI 218 may include the interface to the consumer (e.g. a mobile software application), and/or the interface to the administrative staff of the merchant (e.g. the merchant's internal web portal) who interacts with the code module for code setup purposes.

The UI 218 is usually external to the payment facilitator (i.e. not administered by the payment facilitator).

Code configuration, Request, Response and Decline phases In an embodiment, a code configuration phase involves (i) generating a preliminary code based on the received attributes (for example as described in “step 102” above); and (ii) validating the preliminary code to determine if the code may be used (refer to the steps involved in validating the code described above). Upon successful validation, the code, together with its corresponding attributes, are stored in the code directory database 310d.

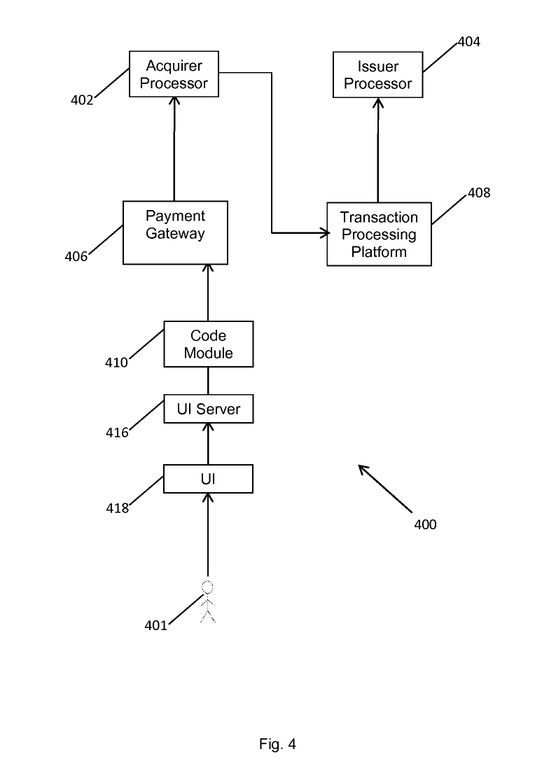

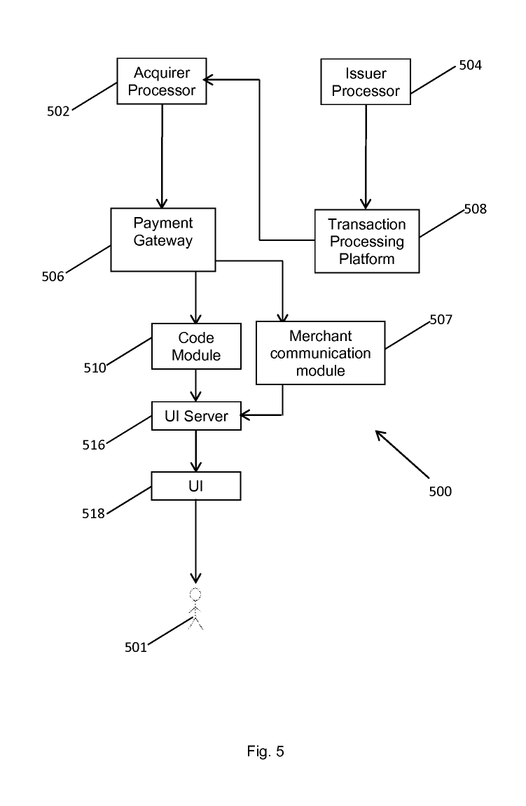

FIGS. 4 and 5 are schematics illustrating the request phase and response phase, respectively, of the method of conducting an electronic transaction, according to an embodiment of the present invention. In an embodiment, once the configuration phase is complete, only the request phase and response phase may need to be executed to conduct subsequent transactions.

With reference to FIG. 4, during the request phase 400, a consumer 401 is informed of a good or service that is sold by a merchant and its corresponding code through broadcast, print and/or digital media. For example, the consumer 401 sees a poster at a bus stop advertising the good or service and its corresponding code. If the consumer 401 wishes to purchase the good or service from the merchant, he initiates the transaction, for example, by using a suitable software application stored on his mobile electronic device. The software application provides a user interface (UI) 418 in which the consumer 401 can input the code. The software application passes the code, a payment request and the consumer's credentials to the UI server 416. The UI server 416 creates a SOAP message and submits the payment request (in the form of a SOAP message) to the payment gateway 406 via the transaction/payment service.

The transaction management component of the code module 410 may perform the following actions before submitting the payment request to the payment gateway 406: (i) retrieve merchant and product identifier using the received code (see step 106), and (ii) extract payment detail (e.g. card number) from the consumer identifier.

The code module 410 passes the merchant and payment details to the payment gateway 406.

Once the payment gateway 406 obtains all the relevant details necessary to execute the transaction, the payment gateway 406 passes the instruction to the acquirer processor 402. In an embodiment, the instruction may be in the form of an ISO message. Thereafter, the acquirer processor 402 submits the authorization request to the transaction processing platform 408. The transaction processing platform 408 in turn submits the authorization request to the issuer processor 404.

If the request is authorized, the response phase 500 is initiated. In an embodiment, the request is authorized if there are sufficient funds in the customer's account. With reference to FIG. 5, during the response phase 500, the issuer processor 504 sends a successful authorization response to the transaction processing platform 508. The authorization response may be in the form of an ISO message. The Message type indicator (MTI) of the ISO message is “0210”, which is an “Issuer Response to Financial Request”. The transaction processing platform 508 sends the successful authorization response to the acquirer processor 502. The acquirer processor 502 in turn sends the successful authorization response to the payment gateway 506.

Thereafter, the payment gateway 506 sends a fulfillment message to the merchant, including consumer detail (e.g. consumer identifier) and product detail (e.g. product identifier, product description, value of product), using the merchant communication module 507. The payment gateway 506 also sends a successful authorization response to the code module 510.

The code module 510 returns the successful response to the UI server 516. The UI server 516 logs the transaction and prepares a transaction confirmation response to the consumer 501. For example, the UI 518 may display a ‘successful transaction’ notification and a ‘bank account balance update’ (if applicable). The consumer 501 may also receive the product (e.g. electronic movie voucher) that he has purchased. The notification may be in the form of a SMS text message or a pop-up message from the mobile application installed on the consumer's mobile device.

If the request is not authorized (e.g. insufficient funds in the customer's bank account), a decline phase may be initiated. The issuer processor may send an unsuccessful authorization response to the transaction processing platform. The unsuccessful authorization response may be in the form of an ISO message. The Message type indicator (MTI) of the ISO message is “0210”, which is an “Issuer Response to Financial Request”. The transaction processing platform sends the unsuccessful authorization response to the acquirer processor. The acquirer processor then passes the unsuccessful response to the payment gateway. Similarly, the payment gateway passes the response to the UI Server, and may add more information about the failure or any necessary actions to be taken. Eventually, the UI may display a ‘unsuccessful transaction’ notification to the consumer, such as via SMS.

With reference to FIGS. 1, 2, 3, 4 and 5, in an embodiment of the invention, the code module 210, 310, 410, 510 may be configured to generate and store a code associated with a first client and a product of the first client (step 102). A second client (having a second client identifier) can use the UI 218, 418, 518 to send the code and/or the second client identifier to the code module 210, 310, 410, 510. Upon receipt of the code and the second client identifier (step 104), the code module 210, 310, 410, 510 may be configured to identify the second client based on the received second client identifier, to determine the product identifier using the received code (step 106) and to determine the first client identifier using received code (step 106). The code module 210, 310, 410, 510 may be configured to generate and send a suitable instruction to the transaction processing platform 208, 408, 508 via the payment gateway 206, 406, 506 to instruct the first client to release the identified product to the identified second client (steps 108 and 110). The transaction processing platform 208, 408, 508 may be in communication with the acquirer processor 202, 402, 502 and the issuer processor 204, 404, 504 to complete the transaction.

It will be appreciated from the above that the terms, “first client identifier”, “second client identifier” and “product identifier” are in the form of data, so that these terms can also be respectively termed as “first client identifier data”, “second client identifier data” and “product identifier data”. Similarly, instructions that are transmitted or received during the above described transactions are also in the form of data and may therefore also be termed as “instruction data”. Further the term “transaction processing platform” may interchangeably refer to a “transaction processing system”.

Embodiments of the invention advantageously allow a second client (consumer) to purchase/redeem products even though the second client is not in the same physical location or digital location as a first client (merchant). The second client can initiate a transaction to purchase/redeem products by simply entering the code via a SMS message or a mobile application installed on his mobile electronic device.

The method(s) of some example embodiments can be at least partly implemented on a computer system 600, schematically shown in FIG. 6. It may be implemented as software, such as a computer program being executed within the computer system 600, and instructing the computer system 600 to conduct the method of the example embodiment. For example, the payment gateway 206 and/or the apparatus can be implemented using the computer system 600.

The computer system 600 comprises a computer module 602, input modules such as a keyboard 604 and mouse 606 and a plurality of output devices such as a display 608, and printer 610.

The computer module 602 is connected to a computer network 612 via a suitable transceiver device 614, to enable access to e.g. the Internet or other network systems such as Local Area Network (LAN) or Wide Area Network (WAN).

The computer module 602 in the example includes a processor 618, a Random Access Memory (RAM) 620 and a Read Only Memory (ROM) 622. The computer module 602 also includes a number of Input/Output (I/O) interfaces, for example I/O interface 624 to the display 608, and I/O interface 626 to the keyboard 604.

The components of the computer module 602 typically communicate via an interconnected bus 628 and in a manner known to the person skilled in the relevant art.

The application program is typically supplied to the user of the computer system 600 encoded on a data storage medium such as a CD-ROM or flash memory carrier and read utilising a corresponding data storage medium drive of a data storage device 630. The databases described above may reside in the storage device 630. The application program is read and controlled in its execution by the processor 618. Intermediate storage of program data may be accomplished using RAM 620.

It is to be understood that the computer system of an embodiment may be generally described as a physical apparatus including at least one processor and at least one memory having computer program code. The at least one memory and the computer program code are configured to, with the at least one processor, cause the physical apparatus to perform the above-described operations of an embodiment. This general description also provides a general description of the example computer system of FIG. 6.

It will be appreciated by a person skilled in the art that numerous variations and/or modifications may be made to the present invention as shown in the embodiments without departing from a spirit or scope of the invention as broadly described. The embodiments are, therefore, to be considered in all respects to be illustrative and not restrictive. cm 1. A method for conducting a transaction, the method comprising:
storing, in a database, a code in association with a first client identifier data and a product identifier data, the first client identifier data identifying a first client device, the product identifier data identifying a product of the first client device;
receiving from a second client device the code and second client identifier data, the second client identifier data identifying the second client device;
determining the product identifier data and the first client identifier data from the database using the received code;
generating instruction data based on the received second client identifier data and the determined product identifier data; and
sending the instruction data to a transaction processing system to instruct the first client device to release the product to the second client device.

2. The method of claim 1, further comprising receiving from the first client device the first client identifier data and the product identifier data, and generating the code based on the received first client identifier data and the received product identifier data.

3. The method of claim 1, further comprising receiving additional data from the second client device, the additional data being associated with the product, and
wherein the instruction data is generated based on the received additional data.

4. The method of claim 3, wherein the instruction data comprises at least one of: the product identifier data, the first client identifier data, the second client identifier data, and the additional data.

5. The method of claim 1, further comprising authorizing and fulfilling the transaction using the transaction processing system.

6. The method of claim 1, further comprising authenticating the second client device based on the received second client identifier data prior to generating the instruction data.

7. The method of claim 1, further comprising sending notification data to the second client device, the notification data confirming whether or not the instruction data has been sent to the first client device.

8. The method of claim 1, further comprising notifying the second client device of the code prior to receiving the code from the second client device.

9. The method of claim 8, wherein notifying comprises broadcasting the code by radio and/or television; displaying the code on one or more printed posters; and/or presenting the code on a website or in an email.

10. The method of claim 1, wherein the product comprises a digital good or service.

11. The method of claim 1, wherein receiving the code from the second client device comprises receiving the code in a short message service (SMS) message or from a mobile software application.

12. The method of claim 1, wherein the code comprises a string of alpha-numeric characters.

13. An apparatus for conducting a transaction, the apparatus comprising:
at least one processor; and
at least one memory including computer program code;
the at least one memory and the computer program code configured to, with at least one processor, cause the apparatus at least to:
store, in a database, a code in association with first client identifier data and product identifier data, the first client identifier data identifying a first client device, the product identifier data identifying a product of the first client device;
receive from a second client device the code and second client identifier data, the second client identifier data identifying the second client device;
determine the product identifier data and the first client identifier data from the database using the received code;
generate instruction data based on the received second client identifier data and the determined product identifier data ; and
send the instruction data to a transaction processing system to instruct the first client device to release the product to the second client device.

14. A non-transitory computer-readable medium having stored thereon processor-executable instructions, to conduct a transaction, that when executed by a processor result in the following:
storing, in a database, a code in association with a first client identifier data and a product identifier data, the first client identifier data identifying a first client device, the product identifier data identifying a product of the first client device;
receiving from a second client device the code and second client identifier data, the second client identifier data identifying the second client device;
determining the product identifier data and the first client identifier data from the database using the received code;
generating instruction data based on the received second client identifier data and the determined product identifier data; and
sending the instruction data to a transaction processing system to instruct the first client device to release the product to the second client device
